(19) United States
(12) Patent Application Publication
(10) Pub. No.: US 2012/0180672 A1
(43) Pub. Date: Jul. 19, 2012

(54) COFFEE BEANS ROASTER

(76) Inventor: Tso-Tung YU, Hukou Township (TW)

(21) Appl. No.: 13/349,743

(22) Filed: Jan. 13, 2012

(30) Foreign Application Priority Data
Jan. 14, 2011 (CN) 201110021239.3
Apr. 15, 2011 (TW) 1000113261

(51) Int. Cl. A23N 12/08

(52) U.S. Cl. 99/342; 99/358

(57) ABSTRACT

A coffee beans roaster includes a machine body. The machine includes a control unit. A roasting body is disposed in the machine body. The roasting body is a tube. The roasting body has an accommodation space therein. An electrothermal film is provided on an outer side of the roasting body. At two conductive electrodes are spaced and disposed on the electrothermal film. Thus, the heat generated by the electrothermal film can be adjusted by the control unit. Raw coffee beans are placed in the accommodation space of the roasting body. Through the electrothermal film, the raw coffee beans can be evenly heated in all directions to shorten the required time and to decrease the consumed power for roasting the raw coffee beans.

### BACKGROUND OF THE INVENTION

1. Field of the Invention

The present invention relates to a roasting device, and more particularly to a coffee beans roaster.

2. Description of the Prior Art

A conventional coffee beans roasting machine comprises a rotated cylinder with a bottom to be heated, or uses fuel gas to heat. The heating way causes loss of heat due to the air. When the bottom of the rotated cylinder is heated, the side of the coffee beans corresponding to the bottom of the rotated cylinder is roasted. The other side of the coffee beans is not roasted, so that the coffee beans cannot be roasted evenly at the same time. This increases the required time and energy to roast raw coffee beans.

Accordingly, the inventor of the present invention has devoted himself based on his many years of practical experiences to solve these problems.

### SUMMARY OF THE INVENTION

The primary object of the present invention is to provide a coffee beans roaster which can roast raw coffee beans in all directions to shorten the required time and to decrease the consumed power for roasting the raw coffee beans.

The coffee beans roaster of the present invention comprises a machine body, a roasting body, at least one electrothermal film, and at least two conductive electrodes. The machine body has a chamber. The machine body has a first opening to communicate with the chamber. The machine body comprises a control unit. The roasting body is disposed in the chamber. The roasting body is a tube. The roasting body has an accommodation space therein. The roasting body has a second opening to communicate with the accommodation space. The second opening corresponds in position to the first opening. The electrothermal film is disposed on an outer side of the roasting body. The conductive electrodes are spaced and disposed on the electrothermal film. The conductive electrodes are electrically connected to a power source.

Thus, raw coffee beans are placed in the accommodation space of the roasting body. Through the electrothermal film, the raw coffee beans can be heated evenly in all directions to shorten the required time and to decrease the consumed power for roasting the raw coffee beans.

### BRIEF DESCRIPTION OF THE DRAWINGS

FIG. 1 is a perspective view of the present invention;

FIG. 2 is another perspective view of the present invention;

FIG. 3 is an exploded view of the present invention;

FIG. 4 is a sectional view of the present invention;

FIG. 5 is a partial sectional view of the present invention; and

FIG. 6 is a perspective showing the roasting body, the electrothermal film and the conductive electrodes of the present invention.

### DETAILED DESCRIPTION OF THE PREFERRED EMBODIMENTS

Embodiments of the present invention will now be described, by way of example only, with reference to the accompanying drawings.

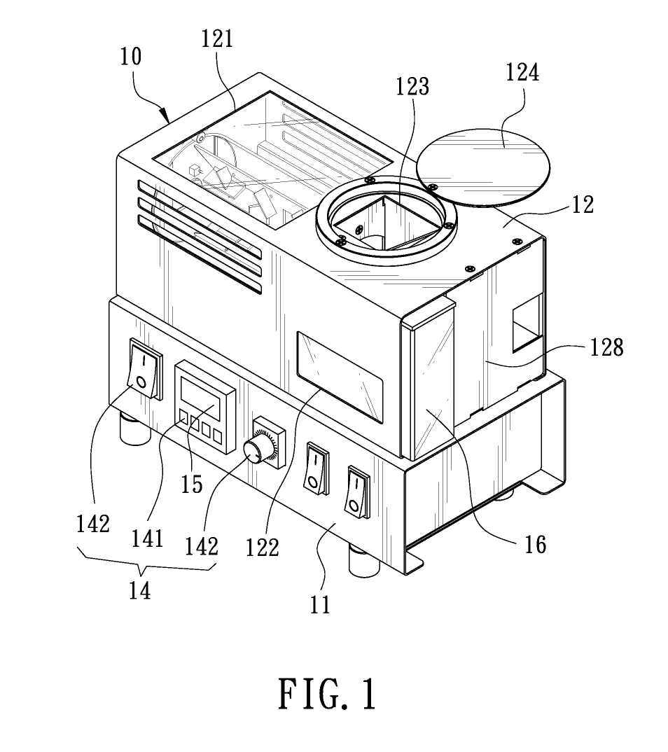

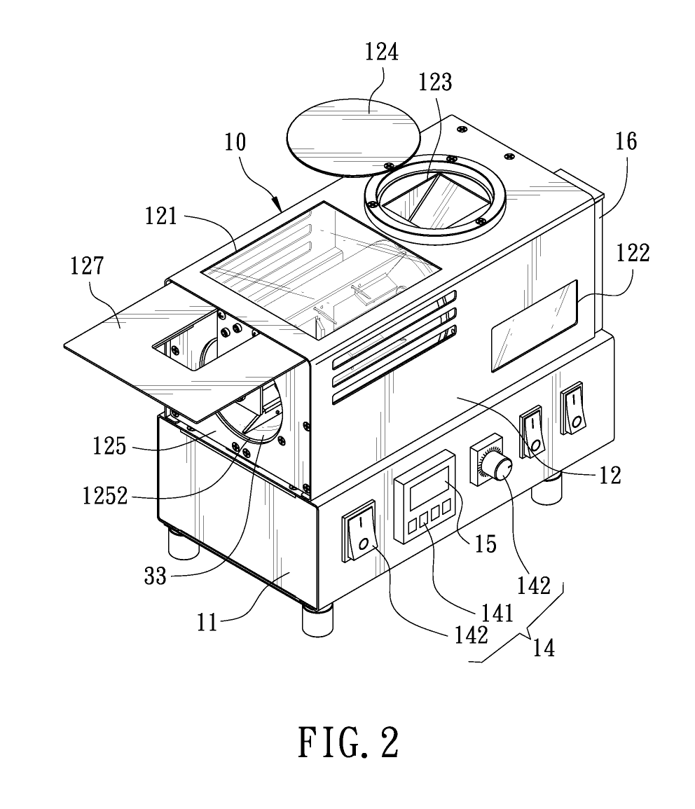

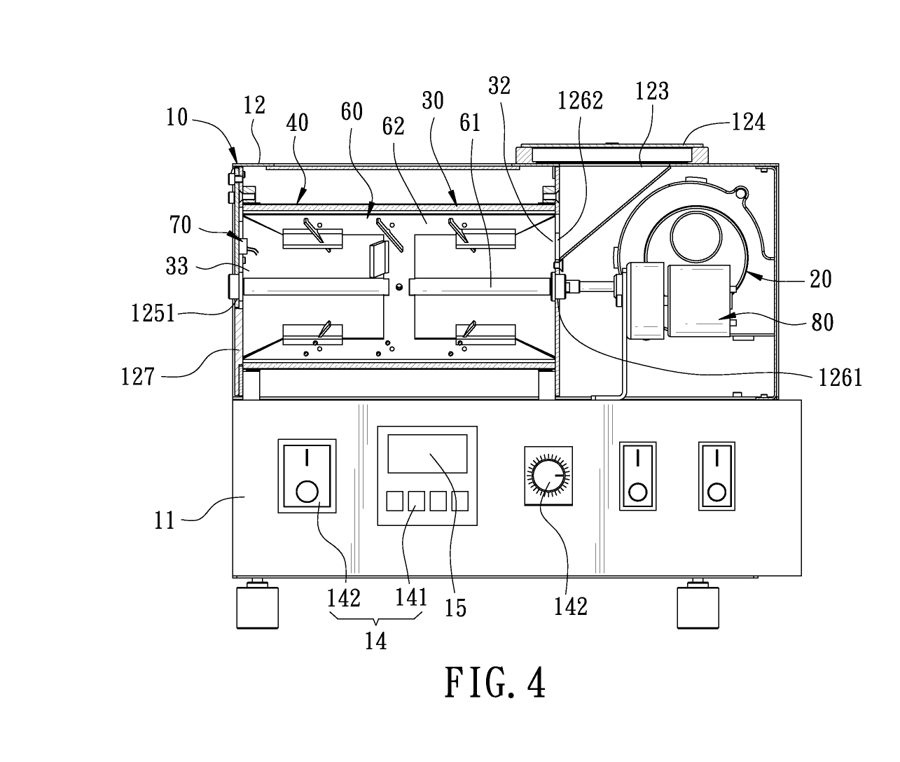

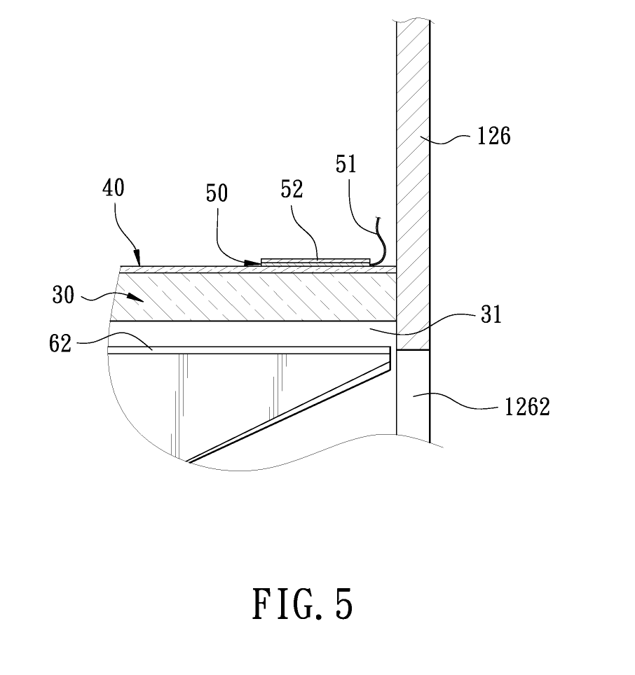

As shown in FIG. 1 through FIG. 5, the coffee beans roaster according to a preferred embodiment of the present invention comprises a machine body 10, an exhaust blower 20, a roasting body 30, at least one electrothermal film 40, at least two conductive electrodes 50, an auxiliary member 60, a temperature sensor 70, and a motor 80.

The machine body 10 comprises a base 11 and a cover 12. When the base 11 is coupled to the cover 12, a chamber 13 is formed between the base 11 and the cover 12. The base 11 comprises a control unit 14 and a display screen 15. In this embodiment, the control unit 14 comprises a plurality of control buttons 141 and a plurality of switch buttons 142. The cover 12 has a first window 121, a second window 122 and a first opening 123. In this embodiment of the present invention, the cover 12 has a rotatable lid 124 corresponding in position to the first opening 123. The rotatable lid 124 is selectively to cover the first opening 123. The cover 12 comprises a first partition 125 and a second partition 126 which are spaced. The first partition 125 has a first pivot hole 1251 at a central portion thereof, and the second partition 126 has a second pivot hole 1261 at a central portion thereof. The first partition 125 has an outlet 1252 close to the first pivot hole 1251. The second partition 126 has an inlet 1262 close to the second pivot hole 1261. The first opening 123 communicates with the inlet 1262. The first partition 125 is provided with a shutter 127 which can be moveably opened and closed so as to close the outlet 1252. The cover 12 further comprises a third partition 128 located at one side of the second partition 126. The third partition 128 has a pericarp outlet 1281 and an air inhaling hole 1282, the pericarp outlet 1281 and the air inhaling hole 1282 communicate with the first opening 123. The first opening 123 corresponds to the pericarp outlet 1281. In this embodiment of the present invention, a receiving box 16 is provided between the base 11 and the cover 12. The receiving box 16 communicates with the pericarp outlet 1281 and the air inhaling hole 1282. In this embodiment of the present invention, the receiving box 16 has a pericarp inlet 161 and an air exhaling hole 162 corresponding in position to the pericarp outlet 1281 and the air inhaling hole 1282, respectively.

The exhaust blower 20 corresponds in position to the air inhaling hole 1282 and is located between the second partition 126 and the third partition 128. The exhaust blower 20 has an electric wire 21 which is electrically connected with one of the switch buttons 142, not shown in the drawings.

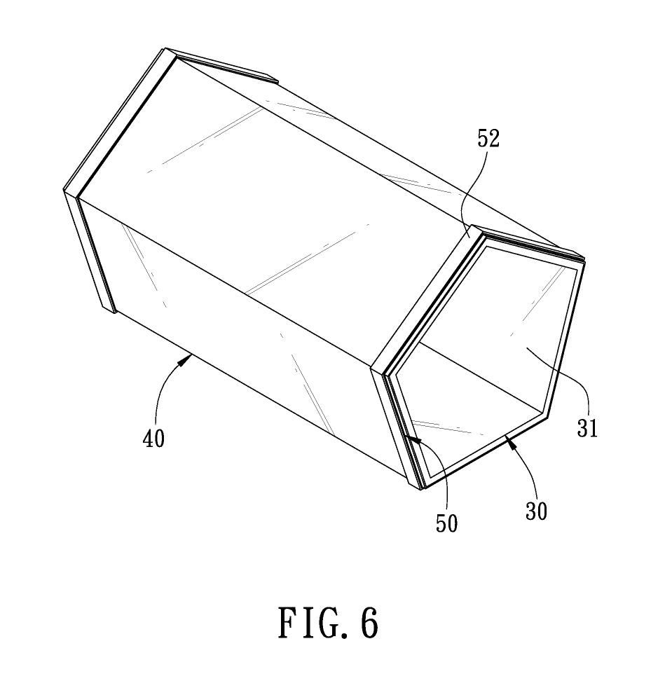

The roasting body 30 is disposed in the chamber 13 and located between the first partition 125 and the second partition 126. In this embodiment, the roasting body 30 is a tube. For the user to see the articles roasted in the roasting body 30, the roasting body 30 can be made of transparent glass. The roasting body 30 has an accommodation space 31 therein. The roasting body 30 has a second opening 32 and a third opening 33 at two transverse opposing sides thereof. The second opening 32 communicates with the first opening 123 and the inlet 1262. Referring to FIG. 6, the roasting body 30 is a polygonal container which is composed of a plurality of transparent plates.

The electrothermal film 40 is disposed around the roasting body 30. In this embodiment of the present invention, the number of the electrothermal film 40 is one to coat the roasting body 30 wholly. There may be a plurality of electrothermal films 40 (not shown in the drawings) which are spaced and disposed on the outer surface of the roasting body 30. The control buttons 141 are used to control power of the electrothermal film 40 so as to control the heat of the electrothermal film 40.

The conductive electrodes 50 are spaced and disposed on the electrothermal film 40. In this embodiment of the present invention, there are two conductive electrodes 50 which are silver liquid. The conductive electrodes 50 are located at opposing sides of the electrothermal film 40. The conductive electrodes 50 are electrically connected to a power source (not shown in the drawings) through a conductive wire 51, respectively, so that the electrothermal film 40 is electrified to generate heat. In this embodiment of the present invention, the surfaces of the conductive electrodes 50 are coated with heat-resist glue 52 to prevent the conductive electrodes 50 from rusting.

The auxiliary member 60 is provided in the accommodation space 31. The auxiliary member 60 comprises a central axle 61 and at least one function portion 62. The central axle 61 is inserted through the center of the roasting body 30. Two ends of the central axle 61 are pivotally connected to the first pivot hole 1251 and the second pivot hole 1261. The end of the central axle 61 relative to the second pivot hole 1261 extends out of the roasting body 30. In this embodiment of the present invention, there are a number of function portions 62 which extend outward along the central axle 61 diametrically and are plate bodies. One end of each function portion 62 is connected to the central axle 61, and another end of the function portion 62 extends outward along the central axle 61 diametrically.

The temperature sensor 70 is disposed in the roasting body 30 and electrically connected with the display screen 15, not shown in the drawings, to detect the temperature in the accommodation space 31. In this embodiment, the temperature sensor 70 is disposed on the first partition 125. The display screen 15 displays the temperature detected by the temperature sensor 70.

The motor 80 is connected with the auxiliary member 60 to drive the auxiliary member 60 rotated. In this embodiment of the present invention, the motor 80 has an electric wire 81 and is electrically connected with one of the switch buttons 142, not shown in the drawings.

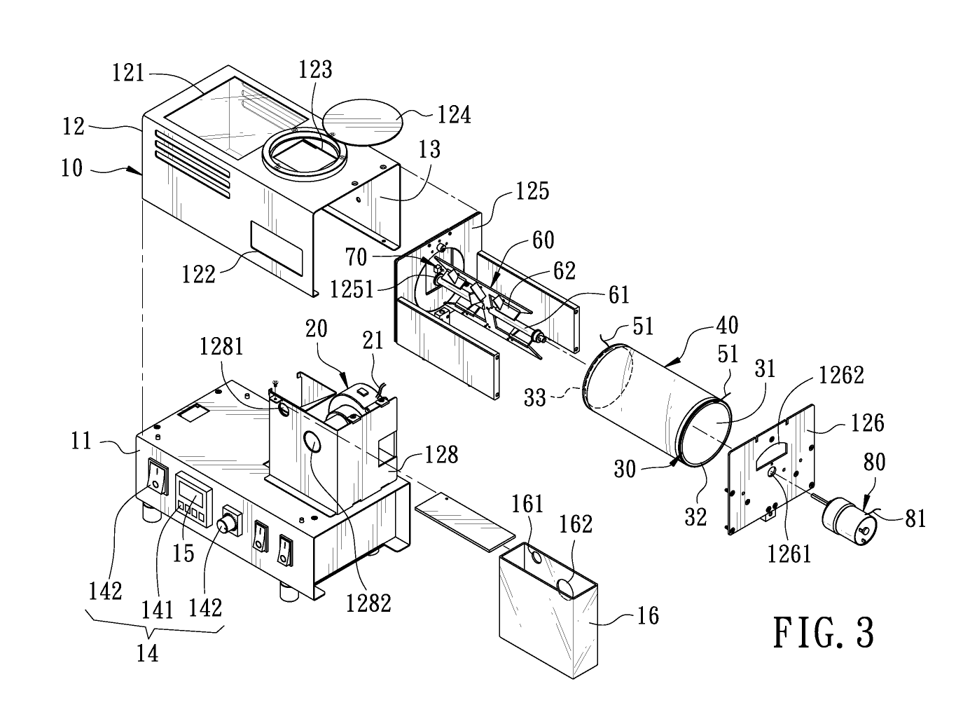

As shown in FIG. 3, when in use, raw coffee beans are poured in from the first opening 123 and enter the accommodation space 31 through the inlet 1262 and the second opening 32. The heat generated by the electrothermal film 40 can be adjusted by the control buttons 141. The user can know the temperature in the accommodation space 31 through the display screen 15. The switch button 142 is turned on to drive the motor 80. The function portions 62 are turned to stir the raw coffee beans to be roasted evenly. Because the electrothermal film 40 surrounds the roasting body 30, the raw coffee beans can be heated in all directions. The required time and consumed power to roast the raw coffee beans are less than those of the conventional roasting tray or coffee beans roaster so as to save energy and time. Besides, another switch button 142 is turned to drive the exhaust blower 20. The exhaust blower 20 exhausts the air in the accommodation space 31 through the pericarp outlet 1281, the pericarp inlet 161, the air exhaling hole 162 and the air inhaling hole 1282 for convection of heat. The pericarps of coffee beans are drawn out and fall in the receiving box 16 through the pericarp outlet 1281 and the pericarp inlet 161. Furthermore, the user can monitor the heated coffee beans through the first window 121 and check whether the receiving box 16 is filled with coffee pericarps. After roasting, the shutter 127 is opened to take out the coffee beans from the outlet 1252. In addition, the cover 12 covers the roasting body 30, so the infrared rays emitted by the electrothermal film 40 are reflected and gathered in the roasting body 30. The outer surface of the roasting body 30 can be wrapped with heat insulation cotton (not shown in the drawings), so that the heat of the electrothermal film 40 can be confined in the roasting body 30 to decrease loss of heat.

The features and expected effects of the present invention are as follow.

1. Raw coffee beans are placed in the accommodation space of the annular heating device of the present invention. Through the electrothermal film, the raw coffee beans can be evenly heated in all directions to shorten the required time and to decrease the consumed power for roasting the raw coffee beans.

2. The heat generated by the electrothermal film can be adjusted by the control buttons, and the display screen displays the temperature of the accommodation space for the user to control the roasting time and temperature according to different coffee beans.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A coffee beans roaster, comprising:
a machine body having a chamber, said machine body having a first opening to communicate with said chamber, said machine body comprising a control unit;
a roasting body disposed in said chamber, said roasting body being a tube, said roasting body having an accommodation space therein, said roasting body having a second opening to communicate with said accommodation space, said second opening corresponding in position to said first opening;
at least one electrothermal film disposed on an outer side of said roasting body; and
at least two conductive electrodes spaced and disposed on said electrothermal film, said conductive electrodes being electrically connected to a power source.

2. The coffee beans roaster as claimed in claim 1, further comprising an auxiliary member, said auxiliary member disposed in said accommodation space, said auxiliary member comprising a central axle and at least one function portion, said central axle being inserted through a central of said roasting body, one end of said function portion being connected to said central axle, another end of said function portion extending outward along said central axle diametrically.

3. The coffee beans roaster as claimed in claim 2, further comprising a motor, said motor being connected with said auxiliary member to drive said auxiliary member rotated.

4. The coffee beans roaster as claimed in claim 1, wherein said machine body comprises a base and a cover, when said base is coupled to said cover, said chamber being formed between said base and said cover, said cover being provided with a shutter which is moveably opened and closed, said roasting member further having a third opening at another end opposite said second opening, said third opening corresponding in position to said shutter, said cover having a transparent window, said roasting body being transparent.

5. The coffee beans roaster as claimed in claim 1, wherein said machine body has a pericarp outlet and an air inhaling hole, said pericarp outlet and said air inhaling hole communicate with said first opening, said machine body further comprising a receiving box, said receiving box communicating with said pericarp outlet and said air inhaling hole, said machine body further comprising an exhaust blower corresponding in position to said air inhaling hole.

6. The coffee beans roaster as claimed in claim 1, wherein said control unit comprises a plurality of control buttons to control power of said electrothermal film.

7. The coffee beans roaster as claimed in claim 1, wherein said machine body comprises a display screen.

8. The coffee beans roaster as claimed in claim 1, wherein said roasting body is a polygonal container which is composed of a plurality of transparent plates.

9. The coffee beans roaster as claimed in claim 1, wherein outer surfaces of said conductive electrodes are coated with heat-resist glue.

10. The coffee beans roaster as claimed in claim 1, further comprising a temperature sensor, said temperature sensor being disposed in said roasting body and electrically connected with said display screen.
